(19) United States
(12) Patent Application Publication
(10) Pub. No.: US 2025/0388084 A1
(43) Pub. Date: Dec. 25, 2025

(54) PRESENTATION CONTROL METHOD, DEVICE FOR IN-VEHICLE GLASS OF VEHICLE, AND VEHICLE

(71) Applicant: SAINT-GOBAIN SEKURIT FRANCE, Thourotte (FR)

(72) Inventors: Xiaonan ZHANG, SHANGHAI (CN); Yiheng ZHANG, SHANGHAI (CN); Lu WANG, SHANGHAI (CN); Ce SHI, SHANGHAI (CN)

(21) Appl. No.: 19/107,951

(22) PCT Filed: Aug. 30, 2023
(86) PCT No.: PCT/CN2023/115736

§ 371 Date: Feb. 28, 2025

(30) Foreign Application Priority Data
Sep. 1, 2022 (CN) 202211067501.2

(51) Int. Cl. B60K 35/231; G06T 7/246; G06T 7/50; G06T 7/73; G06V 20/20; G06V 20/58; G06V 40/20

(52) U.S. Cl. CPC B60K 35/231; G06T 7/246; G06T 7/50; G06T 7/74; G06V 20/20; G06V 20/58; G06V 40/20; B60K 2360/334; G06T 2207/30261

(57) ABSTRACT

A presentation control method for in-vehicle glass of a vehicle, includes obtaining a physical parameter associated with the vehicle; and determining content presented on the in-vehicle glass according to the physical parameter. Further, the present disclosure relates to a presentation control device for in-vehicle glass of a vehicle, wherein the presentation control device includes: a processor; and a memory for storing computer executable instructions that, when executed, cause the processor to execute the presentation control method according to the presentation control method.

### FIELD OF THE DISCLOSURE

The present disclosure relates to the field of control technology related to vehicles, and more specifically to a presentation control method for in-vehicle glass of a vehicle, a presentation control device for in-vehicle glass of a vehicle, a vehicle including the presentation control device for in-vehicle glass of a vehicle, a computer-readable storage medium, and a computer program product.

### BACKGROUND

With the formation of the developing trend of automotive intelligence, the human-vehicle interaction requirements are increasing. In the process of human-vehicle interaction, the information presentation is particularly important.

In the existing technical solution of in-vehicle information presentation, advertising information can be displayed on the rear windshield of a vehicle, for example. However, the presentation of such information is relatively fixed, and the rear windshield can only display pre-recorded advertisements.

### SUMMARY

In the prior art, only pre-recorded advertisements can be generally presented, which makes the information presentation way still single and cannot meet the application requirements of efficient information transmission. On the other hand, this information presentation way will not change with the changes of the environment of the vehicle or changes in surrounding objects, and thus cannot dynamically present information.

In response to the aforementioned technical problems, the inventor of the present disclosure proposes to dynamically determine the content presented on the in-vehicle glass by using a physical parameter associated with the vehicle to improve the presentation effect of information.

Specifically, a first aspect of the present disclosure discloses a presentation control method for in-vehicle glass of a vehicle, the presentation control method includes:
obtaining a physical parameter associated with the vehicle; and
determining content presented on the in-vehicle glass according to the physical parameter.

In this way, the content presented on the in-vehicle glass can be dynamically determined according to the obtained physical parameter associated with the vehicle, thereby enabling more targeted information presentation and improving the efficiency and effectiveness of information presentation.

In one embodiment according to the present disclosure, the presentation control method further includes changing content presented on the in-vehicle glass when the physical parameter changes. In this way, the content presented on the in-vehicle glass can be changed when the physical parameter changes, thereby dynamically adjusting the content presented on the in-vehicle glass in association with the physical parameter, thereby making the content presented on the in-vehicle glass more targeted.

In one embodiment according to the present disclosure, the presentation control method further includes:
determining presentation direction of the content according to the physical parameter, wherein the presentation direction includes one of a direction presenting to the outside of the vehicle and a direction presenting to the inside of the vehicle.

In this way, the presentation direction of the content can be dynamically determined to change the presentation direction of the content as needed, thereby enabling better and more targeted presentation of the content, reducing unnecessary presentation, and improving the efficiency of content presentation.

In one embodiment according to the present disclosure, determining the presentation direction of the content according to the physical parameter further includes: detecting a relative position between a target object and the vehicle; and determining the presentation direction of the content according to the relative position. Preferably, in one embodiment according to the present disclosure, determining the presentation direction of the content according to the relative position further includes: when the target object is located outside the vehicle, the content is presented in a first area of the in-vehicle glass to present the content to the outside of the vehicle; or when the target object is located inside the vehicle, the content is presented in a second area of the in-vehicle glass to present the content to the inside of the vehicle, wherein the second area is different from the first area.

In one embodiment according to the present disclosure, the physical parameter includes at least one of: a distance between the vehicle and a target object; a target object being located inside or outside the vehicle; whether an engine of the vehicle is in a starting state or not; and whether there is a driver or a passenger sitting on a corresponding seat of the vehicle or not. In this way, the physical parameter is embodied as vehicle related states such as engine state, seat vacancy state, or target object's position etc., thereby presenting the content more targeted to improve the efficiency of content presentation in a more targeted manner and thereby enhance information interaction between human and vehicle.

In one embodiment according to the present disclosure, obtaining a physical parameter associated with the vehicle further includes determining the physical parameter by means of a sensor disposed on the vehicle.

In one embodiment according to the present disclosure, obtaining a physical parameter associated with the vehicle further includes: measuring the distance between the target object and the vehicle by means of a distance detection unit; determining the physical parameter by means of image recognition technology; determining the physical parameters by means of a pressure sensor disposed in a seat of the vehicle; or determining the distance between an electronic device associated with the vehicle and the vehicle by means of a processor disposed on a body of the vehicle. In this way, specific components such as the distance detection unit, the pressure sensor, and the processor can be used to determine the corresponding physical parameters, thereby providing a basis for the subsequent determination of the content to be presented and ensuring the improvement of content presentation efficiency.

In one embodiment according to the present disclosure, the electronic device includes a remote key of the vehicle. In this way, the present disclosure can determine the content displayed on the vehicle's window glass according to the distance between the remote key and the vehicle when the driver holding the remote key approaches the vehicle, thereby providing the driver with the necessary information.

In one embodiment according to the present disclosure, determining the physical parameter by means of image recognition technology includes identifying the target object by means of the image recognition technology. In this way, the above technical solution can be achieved by means of the image recognition technology. For example, a pre-stored image of the target object can be stored in the vehicle's memory, then, for example, after obtaining images around the vehicle by means of an in-vehicle camera, the image recognition technology is used to obtain images of the target object which can be compared with pre-stored image as needed to determine whether the target object has the corresponding permission and a corresponding content is presented in a targeted manner.

In one embodiment according to the present disclosure, determining the physical parameter by means of the image recognition technology further includes: determining the distance between the target object and the vehicle by means of image recognition and processing technology. In this way, for example, known image recognition and processing techniques can be used to determine the depth of field of the relative position of the corresponding target object in the obtained image, thereby determining the distance between the target object and the vehicle.

In one embodiment according to the present disclosure, the presentation control method further includes: recognizing the motion posture of the target object by means of the image recognition technology; comparing the motion posture with the corresponding motion posture in the content; and presenting prompt information according to a comparison result. In this way, the motion posture can be determined and compared with the corresponding motion posture in the content, and prompt information can be presented according to the comparison result to help the user correct or optimize his/her motion posture.

In one embodiment according to the present disclosure, the content is associated with a target object. In this way, the traditional presenting way can be changed, that is, to fixedly present pre-stored content. On the contrary, in the technical solution of the present disclosure, the content can be associated with the target object, thereby presenting the content associated with the target object, making the content presentation more targeted and improving the efficiency of information presentation.

In one embodiment according to the present disclosure, the physical parameter includes the shortest distance between the vehicle and a target object located around the vehicle, and the presentation control method further includes: determining whether the shortest distance is lower than a preset threshold; and when the shortest distance is lower than the preset threshold, the content includes alarm information. In this way, when other vehicles, people, or obstacles approach the vehicle, such as when the distance is too close, the alarm information, such as illuminated warning light or icons, can be presented.

In one embodiment according to the present disclosure, the content includes a picture or a video. In this way, the presentation control method according to the present disclosure can not only present individual isolated pictures, but also present continuous images.

In addition, a second aspect of the present disclosure relates to a presentation control device for in-vehicle glass of a vehicle, wherein the presentation control device includes: a processor; and a memory for storing computer executable instructions that, when executed, cause the processor to execute the presentation control method according to any of the embodiments of the first aspect of the present disclosure. In this way, presentation control can be achieved in the form of hardware devices. As previously mentioned, such presentation control can dynamically determine the content presented on the in-vehicle glass according to the obtained physical parameter associated with the vehicle, thereby enabling more targeted information presentation and improving the efficiency and effectiveness of information presentation.

In one embodiment according to the present disclosure, the presentation control device further includes an output unit configured to output the content. In this way, the determined presentation content can be output and then presented.

In one embodiment according to the present disclosure, the output unit includes a projector and/or a display screen. Those skilled in the art should understand that the projector can perform projection, such as be able to present on a vehicle's window glass including a projection film (such as polymer dispersed liquid crystal PDLC). In addition, the in-vehicle glass can also be provided with a display screen for active display, for example, to present the determined content.

In one embodiment according to the present disclosure, the presentation control device further includes an image acquisition unit configured to acquire a picture or a video associated with the target object. In this way, the picture or the video associated with the target object can be obtained to provide a basis for subsequent image recognition and distance determination.

In one embodiment according to the present disclosure, the presentation control device further includes a distance detection unit configured to measure the distance between the target object and the vehicle. In this way, the distance between the target object and the vehicle can be measured to provide a basis for subsequent determination of content.

In one embodiment according to the present disclosure, the distance detection unit is disposed on the A-pillar or B-pillar of the vehicle. Of course, those skilled in the art should understand that such distance detection units can also be disposed in other positions, as long as such disposed positions can measure the distance between the target object and the vehicle.

Furthermore, a third aspect of the present disclosure relates to a vehicle comprising the presentation control device according to any of the embodiments of the second aspect of the present disclosure.

In addition, a fourth aspect of the present disclosure relates to a computer readable storage medium with computer executable instructions stored thereon for executing the presentation control method according to any of the embodiments of the first aspect of the present disclosure.

Finally, a fifth aspect of the present disclosure relates to a computer program product tangibly stored on a computer-readable storage medium and including computer-executable instructions that, when executed, cause at least one processor to execute the presentation control method described in any of the various embodiments of the first aspect of the present disclosure.

In summary, in the technical solution according to the present disclosure, the presentation control method or the presentation control device can dynamically determine the content to be presented on the in-vehicle glass according to the obtained physical parameter associated with the vehicle, thereby enabling more targeted information presentation and improving the efficiency and effectiveness of information presentation.

### BRIEF DESCRIPTION OF THE DRAWINGS

In conjunction with the accompanying drawings and with reference to the following detailed description, the features, advantages, and other aspects of the embodiments of the present disclosure will become more apparent, several embodiments of the present disclosure are shown in an exemplary rather than restrictive manner, in the accompanying drawings:

FIG. 1 shows a flowchart of a presentation control method 100 according to one embodiment of the present disclosure;

FIG. 2 shows a flowchart of a presentation control method 200 according to another embodiment of the present disclosure;

FIG. 3 shows a flowchart of a presentation control method 300 according to yet another embodiment of the present disclosure;

FIG. 4 shows a schematic diagram of a presentation control device 400 according to one embodiment of the present disclosure;

FIG. 5 shows a schematic diagram of a presentation control device 500 according to another embodiment of the present disclosure; and

FIG. 6 shows a schematic diagram of a presentation control device 600 according to yet another embodiment of the present disclosure.

### DETAILED DESCRIPTION

Various exemplary embodiments of the present disclosure are described in detail below with reference to the accompanying drawings. Although the example methods and apparatuses described below include software and/or firmware executed on hardware in other components, it should be noted that these examples are only illustrative and should not be regarded as limited. For example, it can be considered that any or all hardware, software, and firmware components can be implemented exclusively in hardware, exclusively in software, or in any combination of hardware and software. Therefore, although example methods and apparatuses have been described below, those skilled in the art should easily appreciate that the provided examples are not used to limit the ways for implementing these methods and devices.

In addition, the flowcharts and block diagrams in the accompanying drawings illustrate the possible implemented architecture, functions, and operations of the method and system according to various embodiments of the present disclosure. It should be noted that the functions noted in the blocks may also occur in a different order than the order noted in the drawings. For example, two blocks shown in succession may be executed substantially in parallel, or they may sometimes be executed in the reverse order, depending on the functions involved. It should also be noted that each block in the flowchart and/or block diagrams, and the combination of the blocks in the flowchart and/or block diagrams can be implemented using a dedicated hardware-based system that performs the specified functions or operations, or can be implemented using a combination of dedicated hardware and computer instructions.

The terms “including”, “comprising” and similar terms used in this disclosure are open-ended terms, i.e., “including/containing, but not limited to” indicating that other elements may also be included. The term “based on” is open-ended. The term “based on” is “based at least in part on”. The term “one embodiment” means “at least one embodiment”; the term “another embodiment” means “at least one additional embodiment” and so on.

As above mentioned, the existing information presentation method does not change with the changes in the environment or surrounding objects of the vehicle, and cannot dynamically present information. On the other hand, the information that human and vehicles need to interact with is becoming increasingly diverse, which inevitably forms a contradiction. In response to this contradiction, the inventor of the present disclosure came up with the solution of using a physical parameter associated with the vehicle to dynamically determine the content to be presented on the in-vehicle glass, thereby improving the presentation effect of information.

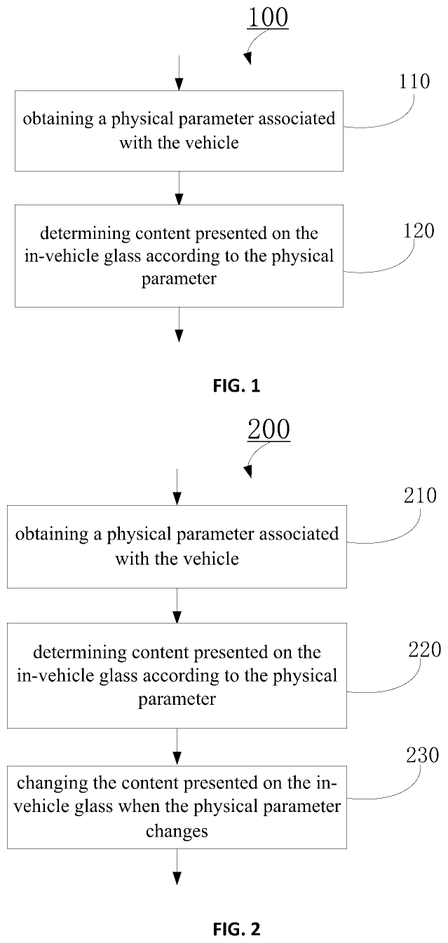

The present disclosure will be described in detail with reference to several embodiments. Firstly, a presentation control method for in-vehicle glass of a vehicle according to the present disclosure will be introduced. Specifically, FIG. 1 shows a flowchart of a presentation control method 100 according to one embodiment of the present disclosure. From FIG. 1, it can be seen that to determine the presentation content on the in-vehicle glass according to a physical parameter associated with a specific physical variable in the real world, the presentation control method 100 according to an embodiment of the present disclosure will first obtain the physical parameter associated with the vehicle in the method step 110, such as the physical distance determined according to the pictures captured by the in-vehicle camera, the physical distance measured by the in-vehicle sensor, the temperature and humidity inside and outside the vehicle, and the physical parameters such as the movement direction, speed, and acceleration of the target object measured by the in-vehicle radar. Then, the presentation control method 100 will determine the content to be presented on the in-vehicle glass according to the physical parameter in the method step 120. For example, welcome information, navigation information, weather forecast, etc. are presented to the driver of the vehicle, or audio and video entertainment information, educational information, or work plan information, etc. are presented to the rear-seat passengers.

Compared with the existing fixed presentation methods, the presentation control method 100 can determine the content to be presented on the in-vehicle glass according to the obtained physical parameter associated with the vehicle in such a way, thereby enabling more targeted information presentation and improving the efficiency and effectiveness of information presentation.

After determining the content to be presented on the in-vehicle glass, the content can also be dynamically adjusted. To illustrate such an adjustment process, FIG. 2 shows a flowchart of a presentation control method 200 according to another embodiment of the present disclosure. From FIG. 2, it can be seen that to determine the content to be presented on the in-vehicle glass according to a physical parameter associated with a specific physical variable in the real world, the presentation control method 200 will first obtain a physical parameter associated with the vehicle in the method step 210. Then, the presentation control method 200 will determine the content to be presented on the vehicle glass according to the physical parameter in the method step 220. The difference from the presentation control method 100 shown in FIG. 1 is that the presentation control method 200 shown in FIG. 2 further includes a method step 230, in which the content to be presented on the in-vehicle glass is changed when the physical parameter changes. For example, when the Bluetooth key of a vehicle is within a certain detection range outside the vehicle, such as a position range of less than 5 meters but more than 3 meters, the driver's nickname can be displayed on or prompt light can be emitted from the in-vehicle glass of the front window on the side of the vehicle near the Bluetooth key, in order to present a welcome message to the driver and provide a better user experience for the driver. Of course, the display of such nicknames and the emitted prompt light can also make it easier for the drivers to find their vehicles. When the distance between the Bluetooth key and the vehicle is getting closer, for example, when it is less than 1 meter, the current weather information or the current vehicle interior temperature information can be presented to the driver. In summary, in this way, the content to be presented on the in-vehicle glass can be changed when the physical parameter changes, thereby dynamically adjusting the content to be presented on the in-vehicle glass in association with the physical parameter, thereby making the content to presented on the in-vehicle glass more targeted.

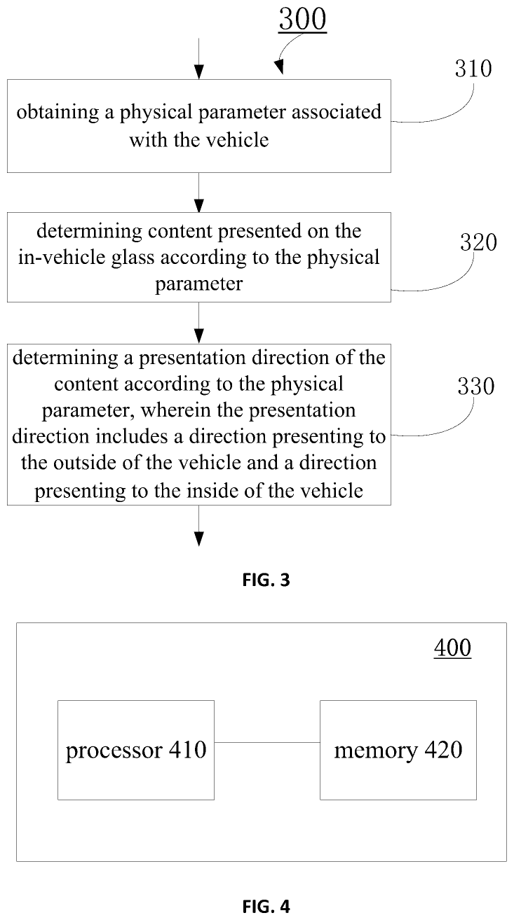

In addition to being able to adjust the content to be presented on the in-vehicle glass, the presentation control method according to the present disclosure can also change the presentation direction of the content to be presented. To illustrate such an adjustment process, FIG. 3 shows a flowchart of a presentation control method 300 according to one embodiment of the present disclosure. From FIG. 3, it can be seen that to determine the presentation content on the in-vehicle glass according to a physical parameter associated with a specific physical variable in the real world, the presentation control method 300 will first obtain a physical parameter associated with the vehicle in the method step 310. Then, the presentation control method 300 will determine the content to be presented on the vehicle glass according to the physical parameter in method step 320. The difference from the presentation control method 100 shown in FIG. 1 is that the presentation control method 300 shown in FIG. 3 also includes a method step 330, in which the presentation control method 300 also determines the presentation direction of the content according to the physical parameter, wherein the presentation direction includes one of a direction presenting to the outside of the vehicle and a direction presenting to the inside of the vehicle. Here, determining the presentation direction of the content according to the physical parameter can be achieved in the following ways, for example, first detecting the relative position between the target object and the vehicle (the relative position here including, for example, whether the target object is located inside or outside the vehicle), and then determining the presentation direction of the content according to the relative position. Specifically, determining the presentation direction of the content according to the relative position further includes: when the target object is located outside the vehicle, the content is presented in the first area of the in-vehicle glass to present the content to the outside of the vehicle; or, when the target object is located inside the vehicle, the content is presented in a second area of the in-vehicle glass to present the content to the inside of the vehicle, wherein the second area is different from the first area. For example, when the in-vehicle camera of the vehicle detects that the driver is located outside the vehicle, the driver's nickname can be displayed on the in-vehicle glass of the front window on the side of the vehicle near the driver to the outside of the vehicle to make it easier for the driver to find his vehicle; when the driver enters the vehicle's interior from the outside and already sits in the driver's cab, if the vehicle still presents content to the outside of the vehicle, the driver cannot see it, at this time, it is necessary to present the required content to the vehicle interior. This is particularly important when the relative position changes. For example, when a driver is detected entering the vehicle from the outside via the in-vehicle camera of the vehicle or the remote key of the vehicle, the presentation position of the content can be changed, such as from the first area to the second area. Correspondingly, for example, when the driver is detected going out from the inside to the outside of the vehicle via the in-vehicle camera of the vehicle or the remote key of the vehicle, the presentation position of the content can also be changed, such as from the second area to the first area. Here, the specific presentation area is related to the optical characteristics of different areas of the in-vehicle glass, for example, the first area is designed to be suitable for rear projection from the vehicle's interior to present the content to the outside of the vehicle, while the second area is designed to be suitable for front projection from the vehicle's interior to present the content to the vehicle's interior. Among them, the first and second areas can be located on the same piece of in-vehicle glass or on different pieces of in-vehicle glass. In summary, the presentation control method 300 can dynamically determine the presentation direction of the content in such a way, so that the presentation direction of the content can be changed as needed, thereby enabling better and more targeted presentation of the content, reducing unnecessary presentations, and thereby improving the efficiency of content presentation.

Those skilled in the art should understand that the method step of determining the presentation direction of the content according to the physical parameter here can also be combined with the method step of changing the content to be presented on the in-vehicle glass when the physical parameter changes in FIG. 2, that is, there are both technical features in one technical solution, so that both the presentation content and the presentation direction can be changed.

In the presentation control methods 100, 200, and 300 shown in FIGS. 1 to 3, the physical parameters involved can be various physical variables. In addition to the aforementioned physical parameters such as the physical distance determined according to the picture captured by the in-vehicle camera, the physical distance measured by the in-vehicle sensor, the temperature and humidity inside and outside the vehicle, and the movement direction, speed, acceleration of the target object measured by the in-vehicle radar, other physical variables can also be involved.

More specifically, the physical parameters at least include at least one of the following: firstly, the physical parameter can be, for example, the distance between the vehicle and the target object, such as the distance between the vehicle and the driver, or the distance between the vehicle and surrounding objects (other vehicles, obstacles, or pedestrians), the distance between the passenger to be picked up and the vehicle, etc.; secondly, the physical parameter can be, for example, whether the target object is located inside or outside the vehicle, such as whether the driver (such as the owner) or passenger of the vehicle is located inside or outside the vehicle; furthermore, the physical parameter can be, for example, whether the engine of the vehicle is in a starting state or not. For example, when the engine of the vehicle is in a stopped state, for example, the power of the in-vehicle battery or the tire pressure of the tires can be displayed, or for example, when the vehicle is an electric vehicle, whether charging is needed or the remaining capacity of the in-vehicle battery or charging information during charging, etc. can be displayed at the time when the electrical motor as the engine is in a stopped state.

Of course, the physical parameter can also be, for example, whether there is a driver or a passenger sitting on the corresponding seat of the vehicle, in order to display on the in-vehicle glass closest to or conveniently visible to the seat where the driver or the passenger is sitting. In this way, the physical parameter is embodied as vehicle related states such as engine state, seat vacancy state, or target object's position, thereby presenting the content in a targeted manner to improve the efficiency of content presentation in a more targeted manner and thereby enhance information interaction between human and vehicles.

In various embodiments of the present disclosure, the physical parameter mentioned above can be obtained in various ways, such as determining the physical parameter by means of the sensor disposed on the vehicle, or receiving such physical parameter from external signal transmitter, such as receiving such physical parameter through a smart device paired with the vehicle such as an electronic device such as a mobile phone or a tablet. When it is necessary to determine the physical parameter, for example, the distance between the target object and the vehicle can be measured by using a distance detection unit. At this time, for example, the orientation of the target object can be determined by the electronic device associated with the vehicle carried by the target object, and then light waves, ultrasonic waves, electromagnetic waves, or other distance detection signals for distance detection can be emitted towards the orientation of the target object by the distance detection unit to achieve distance measurement. Of course, those skilled in the art should understand that the recognition of target objects can also be achieved through other technologies such as image recognition technology. The specific details of image recognition technology will not be elaborated here. Preferably, the distance detection unit is arranged on the A-pillar or B-pillar of the vehicle. Of course, those skilled in the art should understand that such a distance detection unit can also be disposed in other positions, as long as such disposed positions can measure the distance between the target object and the vehicle.

In addition to the approach achieved through the above-mentioned distance detection unit, it is also possible to determine the physical parameter by using image recognition technology, determine the physical parameter by means of a pressure sensor disposed in a seat of the vehicle, or determine the distance between electronic devices associated with the vehicle and the vehicle by means of a processor disposed on a body of the vehicle. For example, it can be achieved by means of the image recognition technology, wherein an image acquisition unit, such as a camera, needs to be disposed on the vehicle. At this time, it will be necessary to first obtain corresponding images by means of an in-vehicle camera, such as capturing images of the surrounding scene of the vehicle, and then to identify people around the vehicle by means of the image recognition technology, such as identifying the driver, then to determine the corresponding physical parameter by the image processing technology (such as analyzing the depth of field of the relative position in the image), such as determining the distance between the driver of the vehicle and the vehicle. When it is necessary to determine whether there is a driver or a passenger sitting in the corresponding seats of the vehicle, it can be achieved, for example, by the image recognition technology using an image acquisition unit (such as a camera), or whether there are people sitting in the corresponding seats can be determined using pressure sensors disposed in the seats of the vehicle.

For example, if the vehicle is a business vehicle, when it provides guest pick-up services, such as at an airport, a train station, or a hotel, it can display relevant information about the picked-up guest, such as name, etc., which can be displayed in the rear side window position, for example, so that the guest can quickly find the vehicle and take a seat to have a good experience of being at home. Specifically, for example, the image recognition technology can also be used to identify whether the guest being picked upis within a certain range of the vehicle, for example, when a guest is detected to be within a range of 20 meters from the vehicle, the sunroof glass of the vehicle can project a specific color to the outside to facilitate the guest's identification of the vehicle; when the guest walks within a range of three to five meters from the vehicle, the relevant information or welcome message of the guest being picked up will be displayed on the rear side window, so that the guest has a good experience of being at home.

In addition to the above implementation way, it is also possible to determine the distance between the electronic device associated with the vehicle and the vehicle, for example, by means of a processor disposed on a body of the vehicle. Here, the electronic device includes a remote key for the vehicle. In this way, the present disclosure can determine the content to be presented on the vehicle's window glass according to the distance between the remote key and the vehicle when the owner or driver holding the remote key approaches the vehicle, thereby providing the required information for the owner or the driver. At this time, the communication between the remote key and the vehicle can be achieved through standard communication protocols such as Bluetooth, WiFi, infrared, Zigbee, etc., at this time, the distance between the vehicle and the corresponding remote key can be determined, for example, by the degree of signal attenuation. In summary, in this way, specific components such as a distance detection unit, a pressure sensor, and a processor can be used to determine the corresponding physical parameters, thereby providing a basis for the subsequent determination of the content to be presented and ensuring the improvement of content presentation efficiency.

In the above embodiments, the content includes a picture or a video. In this way, the presentation control method according to the present disclosure can not only present individual isolated pictures, but also present continuous images. In addition, the content is associated with the target object. For example, what is presented is the name or nickname of the identified target object, or the planned path of the target object to the destination.

In addition to the above implementation ways, in the current context of increasing attention to physical health, it would be beneficial to provide drivers or passengers with for example fitness videos or teaching videos at leisure time, such as waiting for the vehicle to charge. At this time, to provide prompts or displays of fitness effects for corresponding drivers or passengers, the target object can be identified by using the image recognition technology. After the target object is identified, the movement posture of the target object can be further identified by means of the image recognition technology; the motion posture is compared with the corresponding motion posture in the content; and prompt information is presented according to the comparison result. For example, scoring the driver or passenger's motion posture, indicating which part needs to be improved, etc. In this way, the motion posture can be determined and compared with the corresponding motion posture in the content, and prompt information can be presented according to the comparison result to help the user correct or optimize his/her motion posture.

In addition, the presentation control method according to the present disclosure can also achieve an alarm function. At this time, the physical parameter includes the shortest distance between the vehicle and the target object located around the vehicle, and the presentation control method also includes: determining whether the shortest distance is lower than a preset threshold; and when the shortest distance is lower than the preset threshold, the content includes alarm information. Specifically, during implementation, the vehicle is for example provided with a radar capable of 360-degree scanning, which can measure a plurality of distances between the vehicle and a plurality of target objects around the vehicle, and then determine the shortest distance according to the obtained plurality of distances. In addition, for example, a camera which is capable of obtaining omnidirectional images of the surroundings of the vehicle can be disposed on the vehicle, and then image recognition technology can be used to determine a plurality of distances between the vehicle and a plurality of target objects around the vehicle, and the shortest distance can be determined according to the obtained plurality of distances. Furthermore, the vehicle can be provided with a plurality of sensors, and the shortest distance can also refer to the shortest distance of a plurality of distances between a plurality of sensors and the same target object. For example, for the distances measured by sensors respectively located at the front and rear of the vehicle to other vehicles or people close to the front of the vehicle, the distance measured by the sensor on the front side of the vehicle is shorter. Those skilled in the art should understand that the radars and cameras listed here are only exemplary and not restrictive, as long as a plurality of distances between the vehicle and a plurality of target objects around the vehicle can be determined and used to determine the shortest distance, all these implementation ways fall within the scope of protection of this disclosure. In this way, when other vehicles, people, or obstacles approach the vehicle, such as when the distance is too close, the alarm information, such as illuminated warning light or icons, can be presented.

The above technical solution can be implemented not only through software and other control methods, but also through corresponding hardware circuits, for example. In other words, the above presentation control method can be achieved by combining the software stored in a computer-readable storage medium with corresponding hardware components. The computer readable storage medium is loaded with computer readable program instructions for executing various embodiments of the present disclosure. The computer-readable storage medium can be a tangible device that can hold and store instructions used by an instruction executing device. The computer-readable storage media, for example, may be but not limited to an electrical storage device, a magnetic storage device, an optical storage device, an electromagnetic storage device, a semiconductor storage device, or any suitable combination of the above. More specific examples of computer-readable storage media (non-exhaustive) include: portable computer disk, hard disk, Random-access memory (RAM), read-only memory (ROM), erasable programmable read-only memory (EPROM or flash memory), Static random-access memory (SRAM), portable compressed disk read-only memory (CD-ROM), digital multi-function disk (DVD), memory stick, floppy disk, mechanical coding equipment, for example, a Punched card or a convex structure in a groove on which instructions are stored, and any suitable combination of the above. The computer-readable storage medium used here is not interpreted as an instantaneous signal itself, such as radio waves or other freely propagating electromagnetic waves, electromagnetic waves propagated through waveguides or other transmission media (such as optical pulses transmitted through fiber optic cables), or electrical signals transmitted through wires.

FIG. 4 shows a schematic diagram of a presentation control device 400 according to one embodiment of the present disclosure. From FIG. 4, it can be seen that the presentation control device 400 includes a processor (such as a central processing unit (CPU)) 410 and a memory 420 coupled to the processor 410. The memory 420 is configured to store computer executable instructions, causing the processor 410 to execute the presentation control methods 100, 200, and 300 in the above embodiments when the computer executable instructions are executed. The processor 410 and the memory 420 are connected to each other through a bus, and input/output (I/O) interfaces are also connected to the bus. The presentation control device 400 further includes an output unit configured to output the content. In this way, the determined presentation content can be output and then presented.

In addition, the presentation control device 400 can also include a plurality of components connected to the I/O interface (not shown in FIG. 4), including but not limited to: input units, such as keyboards, a mouse, etc.; output units, such as various types of displays, speakers, etc.; storage units, such as magnetic disks, optical disks, etc.; and communication units, such as network cards, modems, wireless communication transceivers, etc. The communication unit allows the presentation control device 400 to exchange information/data with other devices through computer networks such as the Internet and/or various telecommunications networks. In addition, the presentation control device 400 also includes, for example, a distance detection unit (such as a distance sensor) configured to measure the distance between the target object and the vehicle. In this way, the distance between the target object and the vehicle can be measured to provide a basis for subsequent determination of content. The distance detection unit is arranged on the A-pillar or B-pillar of the vehicle. Of course, the persons skilled in this art should understand that such distance detection units can also be disposed in other positions, as long as such disposed positions can measure the distance between the target object and the vehicle.

At this time, the computer executable instructions stored in memory 420 cause the processor 410 to execute the presentation control method according to any of the embodiments of FIGS. 1, 2, and 3 of the present disclosure when executed. In this way, the presentation control can be achieved in the form of a presentation control device. As mentioned above, such presentation control can dynamically determine the content to be presented on the in-vehicle glass according to the obtained physical parameter associated with the vehicle, thereby enabling more targeted information presentation and improving the efficiency and effectiveness of information presentation.

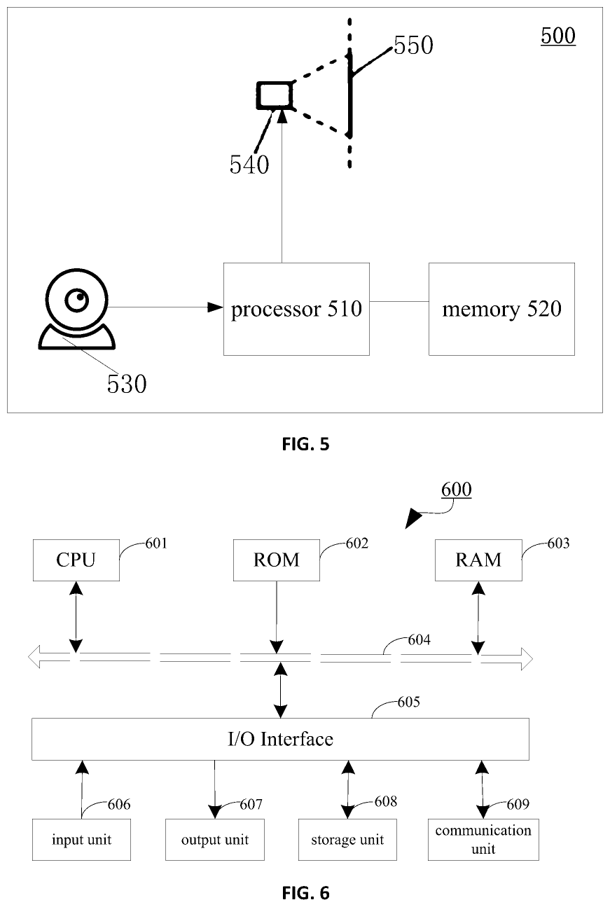

To provide a more vivid description of the presentation control device according to the present disclosure, in addition to the aforementioned processor and memory, FIG. 5 further illustrates the camera 530 and the projector 540 that may be required in certain implementation forms. Here, FIG. 5 shows a schematic diagram of the presentation control device 500 according to another embodiment of the present disclosure. It can be seen from FIG. 5 that the presentation control device 500 includes a processor (such as a central processing unit (CPU)) 510 and a memory 520 coupled to the processor 510. In addition, in the embodiment shown in FIG. 5, the presentation control device 500 further includes a camera 530. The presentation control device 500 can obtain images of corresponding areas by means of an image acquisition unit such as the camera 530, and then determine corresponding physical parameters, such as the distance between the driver and the vehicle, according to the obtained images. Here, the determination of corresponding physical parameters can be achieved by means of the image recognition technology, such as in the corresponding processor. Then, after processing by the processor 510, the content to be projected by projector 540 is determined to be presented on the in-vehicle glass 550 of the front driver's side, for example. That is to say, the output unit at this time can include a projector and/or a display screen. Those skilled in the art should understand that a projector can perform projection, which can be presented on a vehicle's window glass including for example a projection film (such as polymer dispersed liquid crystal PDLC), the projection film can be laminated into the vehicle's window glass or attached to the surface of the vehicle's window glass. In addition, the in-vehicle glass can also be provided with a display screen for active display, for example, to present the determined content. The display screen can be for example a flexible OLED display or an LCD display, which can be laminated into the in-vehicle glass or attached to the surface of the in-vehicle glass.

Accordingly, in another embodiment, the present disclosure provides a computer readable storage medium with computer executable instructions stored thereon, wherein the computer executable instructions are used to perform the presentation control method in various embodiments of the present disclosure.

The present disclosure also provides a computer program product that is tangibly stored on a computer readable storage medium and includes computer executable instructions that, when executed, cause at least one processor to perform the method of various embodiments of the present disclosure.

Generally speaking, the various example embodiments of the present disclosure may be implemented in hardware or special purpose circuits, software, firmware, logic, or any combination thereof. Some aspects may be implemented in hardware, while other aspects may be implemented in firmware or software that may be executed by a controller, microprocessor, or other computing device. When various aspects of the embodiments of the present disclosure are illustrated or described as block diagrams, flowcharts, or using some other graphical representation, it will be appreciated that the blocks, apparatuses, systems, techniques, or methods described herein can be regarded as non-limited examples are implemented in hardware, software, firmware, dedicated circuits or logic, general-purpose hardware or controllers or other computing devices, or some combination thereof.

FIG. 6 shows a schematic diagram of a presentation control device 600 according to yet another embodiment of the present disclosure. It should be appreciated that the presentation control device 600 may be implemented to implement the functions of the presentation control method 100 in FIG. 1, the presentation control method 200 in FIG. 2 or the presentation control method 300 in FIG. 3. It can be seen from FIG. 6 that the presentation control device 600 includes a central processing unit (CPU) 601 (for example, a processor), which can perform various appropriate actions and processes according to the computer program instructions stored in a read-only memory (ROM) 602 or the computer program instructions loaded from a storage unit 608 to a random access memory (RAM) 603. In the RAM 603, various programs and data required for the operation of the presentation control device 600 can also be stored. The CPU 601, the ROM 602, and the RAM 603 are connected to each other via a bus 604. An input/output (I/O) interface 605 is also connected to the bus 604.

A number of components in the presentation control device 600 are connected to the I/O interface 605, including: an input unit 606, such as a keyboard, a mouse, etc.; an output unit 607, such as various types of displays, speakers, etc.; and a storage unit 608, such as a magnetic disk, an optical disk, etc.; and a communication unit 609, such as a network card, a modem, a wireless communication transceiver, etc. The communication unit 609 allows the presentation control device 600 to exchange information/data with other apparatuses through a computer network such as the Internet and/or various telecommunication networks.

The various methods described above, for example, a presentation control method can be executed by the processing unit 601. For example, in some embodiments, the presentation control method 100 may be implemented as a computer software program, which is tangibly included in a machine-readable medium, such as the storage unit 608. In some embodiments, part or all of the computer program may be loaded and/or installed on the device 600 via the ROM 602 and/or the communication unit 609. When the computer program is loaded into the RAM 603 and executed by the CPU 601, one or more actions or steps of the method 100 described above can be executed, i.e.:
obtaining a physical parameter associated with the vehicle; and
determining content presented on the in-vehicle glass according to the physical parameter.

In one embodiment according to the present disclosure, when the computer program is loaded into the RAM 603 and executed by the CPU 601, the CPU 601 is caused to change the content presented on the in-vehicle glass when the physical parameter changes.

In one embodiment according to the present disclosure, when the computer program is loaded into the RAM 603 and executed by the CPU 601, the CPU 601 is caused to:
determine presentation direction of the content according to the physical parameter, wherein the presentation direction includes one of a direction presenting to the outside of the vehicle and a direction presenting to the inside of the vehicle.

In one embodiment according to the present disclosure, the physical parameter includes at least one of: a distance between the vehicle and the target object; the target object is located inside or outside the vehicle; whether the engine of the vehicle is in a starting state or not; and whether there is a driver or a passenger sitting on the corresponding seat of the vehicle or not.

In one embodiment according to the present disclosure, obtaining a physical parameter associated with the vehicle further includes: determining the physical parameter by means of a sensor disposed on the vehicle.

In one embodiment according to the present disclosure, obtaining a physical parameter associated with the vehicle further includes: measuring the distance between the target object and the vehicle by means of a distance detection unit; determining the physical parameter by means of image recognition technology; determining the physical parameter by means of a pressure sensor disposed in the seat of the vehicle; or determining the distance between an electronic device associated with the vehicle and the vehicle by means of a processor disposed on a body of the vehicle.

In one embodiment according to the present disclosure, the electronic device includes a remote key of the vehicle.

In one embodiment according to the present disclosure, determining the physical parameter by means of image recognition technology includes: identifying the target object by means of the image recognition technology.

In one embodiment according to the present disclosure, determining the physical parameter by means of the image recognition technology further includes: determining the distance between the target object and the vehicle by means of the image recognition and processing technology.

In one embodiment according to the present disclosure, when the computer program is loaded into the RAM 603 and executed by the CPU 601, the CPU 601 is caused to:
recognize the motion posture of the target object by means of the image recognition technology; compare the motion posture with the corresponding motion posture in the content; and present prompt information according to a comparison result.

In one embodiment according to the present disclosure, the content is associated with the target object.

In one embodiment according to the present disclosure, the physical parameter includes the shortest distance between the vehicle and a target object located around the vehicle, and the presentation control method further includes: determining whether the shortest distance is lower than a preset threshold; and when the shortest distance is lower than the preset threshold, the content includes alarm information.

In one embodiment according to the present disclosure, the content includes a picture or a video.

Although it is described above that the various example embodiments of the present disclosure can be implemented in hardware or a dedicated circuit, the above-mentioned data processing device for data processing of blockchain can be implemented in the form of hardware or software, which can be achieved in the form of software, because: in the 1990s, a technological improvement can easily belong to the improvement of the hardware (for example, the improvement of the circuit structure of diodes, transistors, switches, etc.) or the improvement of software (for example, the improvement of method flow). However, with the continuous development of technology, the improvement of many method processes nowadays can almost be implemented by programming the improved method process into the hardware circuit, in other words, the corresponding hardware circuit structure can be obtained by programming different programs of the hardware circuit, the change of the hardware circuit structure is implemented, that is, the improvement of such a method flow can also be regarded as a direct improvement of the hardware circuit structure. Therefore, it cannot be considered that the improvement of a method flow cannot be implemented by hardware entity modules. For example, a programmable logic device (PLD) (such as a Field Programmable Gate Array (FPGA)) is an integrated circuit whose logic function is determined by the user's programming of the device. It is programmed by the designer to “integrate” a digital system on a programmable logic device without requiring the chip manufacturer to design and manufacture a dedicated integrated circuit chip. Moreover, instead of manually making integrated circuit chips, this kind of programming is mostly implemented using “logic compiler” software, which is similar to the software compiler used in program development and writing, but the original code must also be written in a specific programming language before compiling, which is called Hardware Description Language (HDL), and HDL is not only one language, but there are many languages, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc., currently the most commonly used is VHDL (Very-High-Speed Integrated Circuit Hardware Description Language) and Verilog. It should also be clear to those skilled in the art that the method flow needs to be logic programmed using the above-mentioned hardware description languages into an integrated circuit, which can easily obtain the hardware circuit that implements the logic method flow.

The computer readable program instructions or computer program products used to execute various aspects of the disclosure of the present disclosure can also be stored in the cloud. When needed, the user can access the computer-readable program instructions used to execute one aspect of the disclosure of the present disclosure through the mobile Internet, the fixed network or other networks, so as to implement the technical solutions disclosed in each aspect of the disclosure of the present disclosure.

The foregoing descriptions are only alternative embodiments of the disclosure of the present disclosure, and are not used to limit the embodiments of the present disclosure, for those skilled in the art, the embodiments of the present disclosure may have various modifications and changes. . . . Any modification, equivalent replacement, improvement, etc., made within the spirit and principle of the embodiment of the present disclosure should be included in the protection scope of the embodiment of the present disclosure.

Although the embodiments of the present disclosure have been described with reference to several specific embodiments, it should be understood that the embodiments of the present disclosure are not limited to the disclosed specific embodiments. The embodiments of the present disclosure are intended to cover various modifications and equivalent arrangements within the spirit and scope of the appended claims. The scope of the claims accords with the broadest interpretation, so as to include all such modifications and equivalent structures and functions.

1. A presentation control method for in-vehicle glass of a vehicle, wherein the presentation control method comprises:
obtaining a physical parameter associated with the vehicle; and
determining content presented on the in-vehicle glass according to the physical parameter.

2. The presentation control method according to claim 1, wherein the presentation control method further comprises:
changing the content presented on the in-vehicle glass when the physical parameter changes.

3. The presentation control method according to claim 1, wherein the presentation control method further comprises:
determining a presentation direction of the content according to the physical parameter, wherein the presentation direction includes one of a direction presenting to the outside of the vehicle and a direction presenting to the inside of the vehicle.

4. The presentation control method according to claim 3, wherein determining the presentation direction of the content according to the physical parameter further comprises:
detecting a relative position between a target object and the vehicle; and
determining the presentation direction of the content according to the relative position.

5. The presentation control method according to claim 4, wherein determining the presentation direction of the content according to the relative position further comprises:
when the target object is located outside the vehicle, the content is presented in a first area of the in-vehicle glass to present the content to the outside of the vehicle; or
when the target object is located inside the vehicle, the content is presented in a second area of the in-vehicle glass to present the content to the inside of the vehicle,
wherein the second area is different from the first area.

6. The presentation control method according to claim 1, wherein the physical parameter includes at least one of:
a distance between the vehicle and a target object;
a target object being located inside or outside the vehicle;
whether an engine of the vehicle is in a starting state or not; and
whether there is a driver or a passenger sitting on a corresponding seat of the vehicle or not.

7. The presentation control method according to claim 1, wherein obtaining a physical parameter associated with the vehicle further comprises determining the physical parameter by means of a sensor disposed on the vehicle.

8. The presentation control method according to claim 1, wherein obtaining a physical parameter associated with the vehicle further comprises:
measuring the distance between a target object and the vehicle by means of a distance detection unit;
determining the physical parameter by means of image recognition technology;
determining the physical parameters by means of a pressure sensor disposed in a seat of the vehicle; or
determining the distance between an electronic device associated with the vehicle and the vehicle by means of a processor disposed on a body of the vehicle.

9. The presentation control method according to claim 8, wherein the electronic device includes a remote key of the vehicle.

10. The presentation control method according to claim 8, wherein determining the physical parameter by means of image recognition technology comprises:
identifying the target object by means of the image recognition technology.

11. The presentation control method according to claim 10, wherein determining the physical parameter by means of the image recognition technology further comprises:
determining the distance between the target object and the vehicle by means of image recognition and processing technology.

12. The presentation control method according to claim 10, wherein the presentation control method further comprises:
recognizing a motion posture of the target object by means of the image recognition technology;
comparing the motion posture with a corresponding motion posture in the content; and
presenting prompt information according to a comparison result.

13. The presentation control method according to claim 1, wherein the content is associated with a target object.

14. The presentation control method according to claim 1, wherein the physical parameter includes a shortest distance between the vehicle and a target object located around the vehicle, and the presentation control method further comprises:
determining whether the shortest distance is lower than a preset threshold; and
when the shortest distance is lower than the preset threshold, the content includes alarm information.

15. The presentation control method according to claim 1, wherein the content includes a picture or a video.

16. A presentation control device for in-vehicle glass of a vehicle, wherein the presentation control device comprises:
a processor; and
a memory for storing computer executable instructions that, when executed, cause the processor to execute the presentation control method according to claim 1.

17. The presentation control device according to claim 16, wherein the presentation control device further comprises an output unit configured to output the content.

18. The presentation control device according to claim 17, wherein the output unit includes a projector and/or a display screen.

19. The presentation control device according to claim 16, wherein the presentation control device further comprises:
an image acquisition unit configured to acquire a picture or a video associated with the target object.

20. The presentation control device according to claim 16, wherein the presentation control device further comprises:
a distance detection unit configured to measure the distance between the target object and the vehicle.

21. The presentation control device according to claim 20, wherein the distance detection unit is disposed on the A-pillar or B-pillar of the vehicle.

22. A vehicle, wherein the vehicle comprises the presentation control device according to claim 16.

23. A non-transitory computer readable storage medium with computer executable instructions stored thereon for executing the presentation control method according to claim 1.

24. (canceled)
